(19) United States
(12) Patent Application Publication
(10) Pub. No.: US 2013/0277511 A1
(43) Pub. Date: Oct. 24, 2013

(54) HOLDER FOR A PET TOY

(71) Applicant: Allan Wendling, New Lothrop, MI (US)

(72) Inventor: Allan Wendling, New Lothrop, MI (US)

(21) Appl. No.: 13/692,165

(22) Filed: Dec. 3, 2012

Related U.S. Application Data
(63) Continuation-in-part of application No. 13/454,374, filed on Apr. 24, 2012.

(51) Int. Cl. F16M 13/00; A01K 29/00

(52) U.S. Cl. CPC F16M 13/00; A01K 29/00
USPC 248/176.1

(57) ABSTRACT

A holder for a pet toy having a base and a support secured to and extending upwardly from a top of the base. The support also includes an upper support surface with a groove dimensioned to receive a pet toy. An elastic strap is secured to the base and extends over the support surface to releasably attach a pet toy positioned in between the strap and the support surface of the support. Alternatively, a pin extends through registering holes in the support and the pet toy to secure the pet toy to the support.

### CROSS-REFERENCE TO RELATED APPLICATIONS

This application is a continuation-in-part of U.S. patent application Ser. No. 13/454,374 filed Apr. 24, 2012, and entitled “Holder for a Pet Toy”.

### BACKGROUND OF THE INVENTION

I. Field of the Invention

The present invention relates to a holder for a pet toy.

II. Description of Related Art

Many people own pets that are kept inside the house. Some pets, and in particular dogs, instinctively chew objects found within the household. In order to accommodate this instinctive chewing by the pet dog, and also to protect other items within the household, many pet owners provide the dog with a chew bone or other chew toy.

One problem with chew toys for pets, and particularly pet dogs, is that the dog will drag the chew toy around the house, oftentimes losing it. Similarly, the pet may leave the chew toy in places around the home where the chew toy is unwanted.

### SUMMARY OF THE PRESENT INVENTION

The present invention provides a holder for a pet toy which overcomes the above mentioned disadvantages of the prior art.

In brief, the present invention provides a holder for a pet toy having a base with a top. A support is secured to and extends upwardly from the top of the base and that support in turn has an upper support surface. This upper support surface preferably includes a central notch designed to receive a portion of a pet chew toy.

In one embodiment with a pet chew toy positioned within the notch, an elastic strap is fixedly secured at one end to the support, extends over the upper support surface, and is releasably secured to the support at its other end. In doing so, the strap releasably attaches the pet toy positioned in between the strap and the support surface to the support. The releasable attachment of the strap to the support is preferably adjustable in length in order to accommodate different sizes of pet toys positioned on the support.

In practice, with the pet toy positioned on the upper surface of the support and secured in place with the elastic strap, the pet is able to chew the pet toy but unable to remove the chew toy from the support. Furthermore, the base is dimensioned so that, when the pet is chewing on the chew toy, at least a portion of the weight of the pet is exerted on the top surface of the base thus effectively holding the base with its attached chew toy in a stationary position. In this fashion, the pet is unable to either remove the pet toy from the support or to move the entire holder for the pet toy.

In a second preferred embodiment, a pair of aligned holes are formed through the support so that the holes extend through the notch. A hole is formed or drilled in the pet toy so that, with the pet toy positioned within the notch, the hole in the pet toy is aligned with the opening extending through the support and across the notch. With the pet toy so positioned, a pin is inserted through the registering holes in the support as well as the hole in the pet toy thus securing the pet toy to the support. Preferably, a friction fit between the pin and the support retains the pin in place, although other means may alternatively be used.

### BRIEF DESCRIPTION OF THE DRAWING

A better understanding of the present invention will be had upon reference to the following detailed description when read in conjunction with the accompanying drawing, wherein like reference characters refer to like parts throughout the several views, and in which:

FIG. 1 is a perspective view illustrating a preferred embodiment of the present invention;

FIG. 2 is a side view illustrating the preferred embodiment of the invention;

FIG. 3 is a rear view of the preferred embodiment of the invention;

FIG. 4 is an exploded view of the pet toy holder;

FIG. 5 is a perspective view illustrating a second preferred embodiment of the present invention; and

FIG. 6 is a diagrammatic view illustrating the operation of the second preferred embodiment of the invention.

### DETAILED DESCRIPTION OF A PREFERRED EMBODIMENT OF THE PRESENT INVENTION

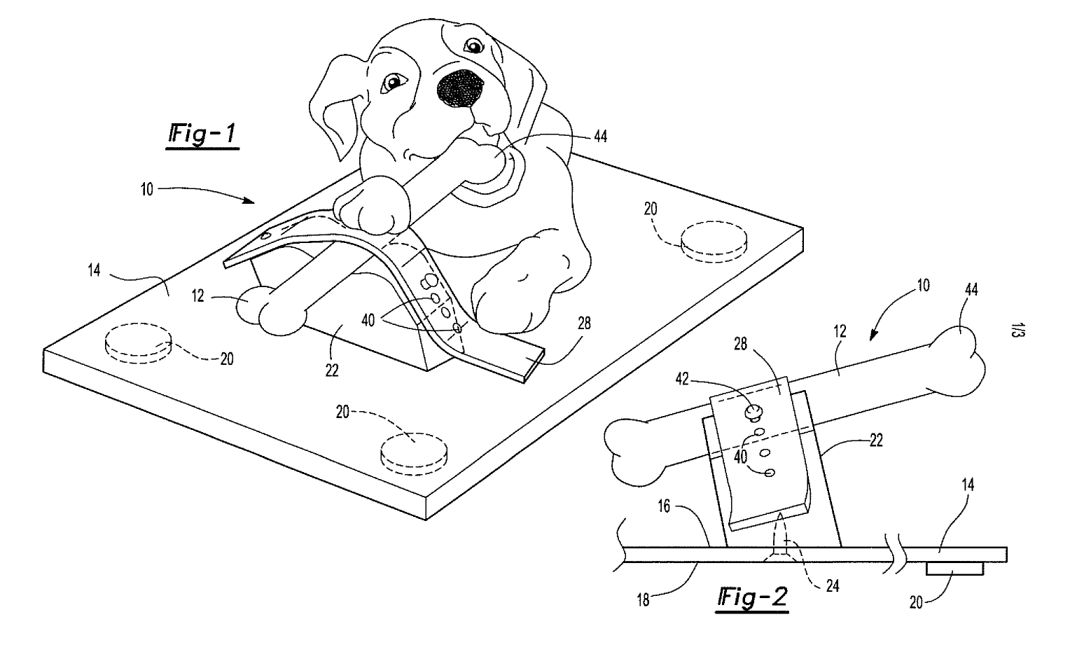

With reference first to FIGS. 1 and 2, a preferred embodiment of a holder 10 for a pet toy 12 is shown. The holder 10 includes a generally planar base 14 having both an upper surface 16 and a lower surface 18. The base 14 is adapted to be positioned on a floor with its lower surface 18 facing the floor and its upper surface 16 facing upwardly away from the floor. Anti-scratch cushions 20 (only one shown) are preferably attached to the bottom surface 18 of the base 14 to protect the floor surface.

A support 22 is secured to the base 14 in any conventional fashion, such as by screws 24. The support 22 is preferably positioned near the center of the base 14 for a reason to be subsequently described.

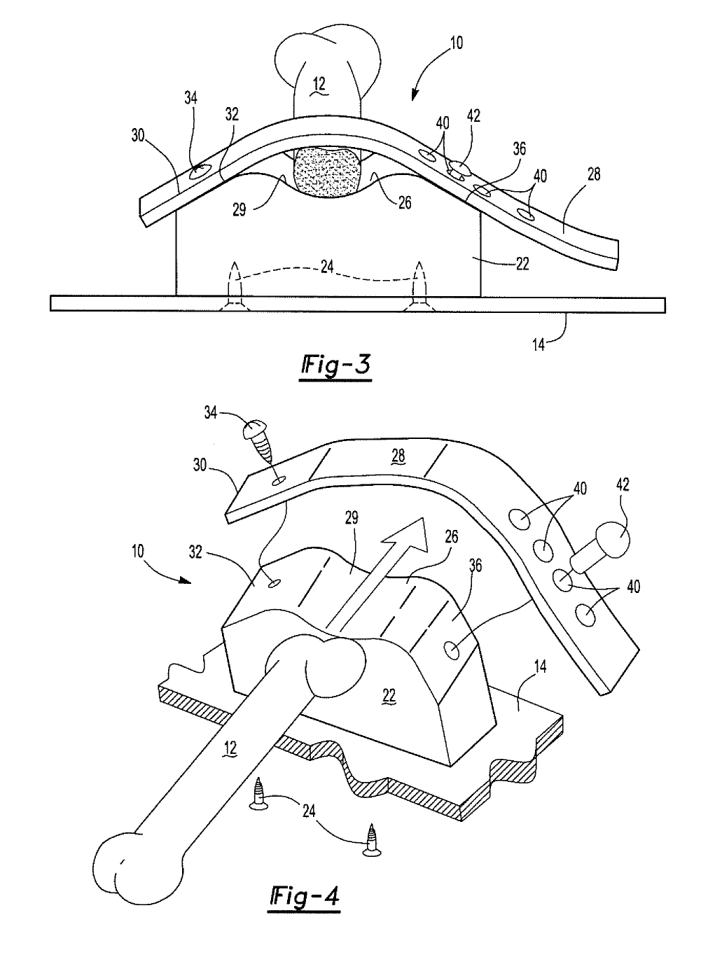

Referring to FIGS. 3 and 4, the support 22 includes an upper support surface 26 preferably having a central notch 28. This notch 28, furthermore, is dimensioned so that at least a portion of the pet toy 12 can be positioned within the notch 28.

As best shown in FIG. 2, the support 22 is generally planar with its plane intersecting the plane of the base 14 at an acute angle. The upper support surface 26 of the support 22 also includes at least a portion that is planar and which intersects the plane of the base 14 at an acute angle.

With reference now to FIGS. 3 and 4, an elongated elastic strap 28 has one end 30 secured to one side 32 of the support 22 by any conventional fashion, such as a fastener 34. The end 30 of the elastic strap 28 may be either fixedly secured to the support 22, or removably secured to the support 22, but is preferably fixedly secured.

With the pet toy 12 positioned within the notch 28, the strap 28 extends over the pet toy 12 so that the pet toy 12 is entrapped in between the strap 28 and the support surface 26 of the support 22. The other end 34 is then releasably attached to the side 36 opposite the side 32 of the support so that the elastic strap 28 is in a state of tension. Any conventional means may be used to detachably attach the end 34 of the strap 28 to the support 22, but in the preferred embodiment of the invention, the strap 28 includes a plurality of longitudinally spaced openings 40 while a pin 42 with an enlarged head is attached to the side 36 of the support 22. The tension on the strap 28 may be adjusted by selecting different holes 40 and the strap 28 is positioned so that the pin 42 extends through one of the holes 40 thus releasably securing the end of the strap 28 to the support 22.

As shown in FIGS. 1 and 2, with the pet toy 12 attached to the support 22 as described, one end 44 of the pet toy 12 is angled upwardly due to the angled upper support surface 29 to hold the pet toy 12 in a desirable position and provide easy access for the pet. Furthermore, when the pet is chewing on the pet toy 12, one or more paws of the pet is positioned on top of the base 14 thus holding the base 14 in place.

In practice, the elastic strap 28 effectively retains the pet toy 12 to the support 22 so that the pet toy 12 cannot be removed and lost. However, the elastic strap 28 does allow some movement of the pet toy 12 so that the dog can position the pet toy as desired. When desired, a new pet toy may be easily replaced by simply releasing the end 34 of the elastic strap and placing a new pet toy on the support surface 26 of the support 22 and then reattaching the elastic strap 28 to the support 22.

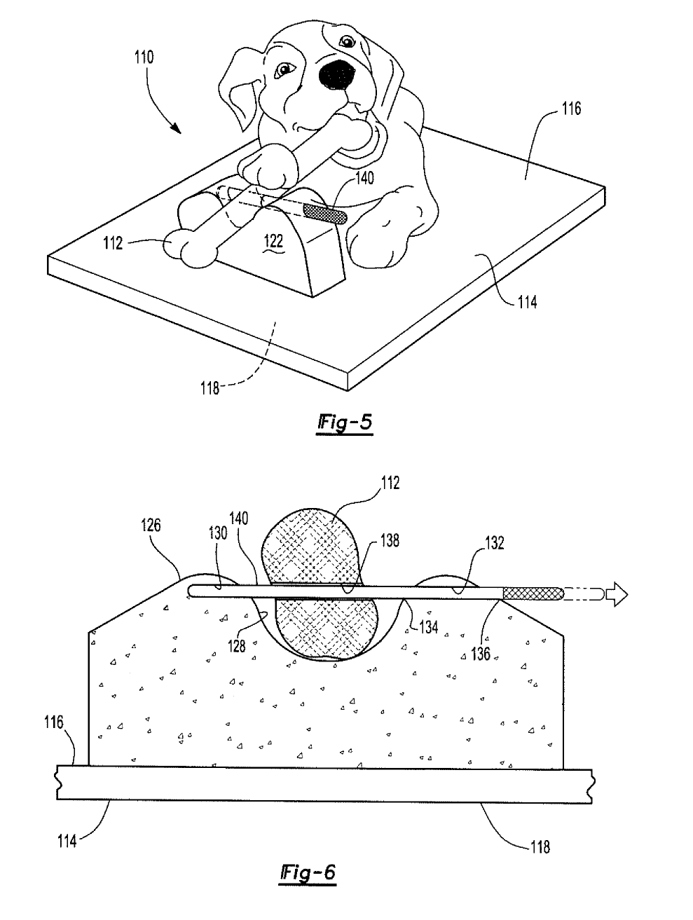

With reference now to FIGS. 5 and 6, a second preferred embodiment of a holder 110 for a pet toy 112 is shown. The holder 110 includes a generally planar base 114 having both an upper surface 116 and a lower surface 118. The base 114 is adapted to be positioned on a floor with its lower surface 118 facing the floor and its upper surface 116 facing upwardly away from the floor. Anti-scratch cushions (not shown) are preferably attached to the bottom surface 118 of the base 114 to protect the floor surface.

A support 122 is secured to the base 114 in any conventional fashion, such as by screws, gluing, or the like. The support 122 is preferably positioned near the center of the base 114.

Still referring to FIGS. 5 and 6, the support 122 includes an upper surface 126 having a central notch 128. The notch 128, furthermore, is dimensioned so that at least a portion of the pet toy 112 can be positioned within the notch 128.

A pair of holes 130 and 132 are formed through the support 122 so that the holes 130 and 132 are aligned with each other. Furthermore, the holes 130 and 132 are coaxial and so that the axes of the holes 130 and 132 extend across the notch 128 in the support 122 near the upper portion of the notch 128. Furthermore, at least one hole 132 extends entirely through the support 122 so that one end 134 of the hole 132 is open to the notch 128, while the other end 136 is open to one side of the support 122 spaced from the notch 128.

As best shown in FIG. 6, the pet toy 112 also includes a throughbore 138 which has a diameter substantially the same, or slightly larger, than the diameter of the holes 130 and 132. Furthermore, with the pet toy 112 positioned in the notch, the hole 138 in the pet toy registers with the holes 130 and 132.

In order to secure the pet toy 112 to the holder 110, the pet toy 112 is positioned within the notch 128 so that its through hole 138 is aligned and registers with the holes 132 and 130 in the support 122. Thereafter, a pin 140 is inserted through the registering holes 130 and 132 in the support 122 as well as through the hole 138 in the pet toy 112 thereby securing the pet toy 112 to the support 122. Preferably, the pin 140 is retained in position by a friction fit between the pin 140 and the support 122. This frictional attachment may be enhanced by providing a knurl or similar deformation along portions of the pin 140. Furthermore, the pin 140 may be removed, as shown in phantom line in FIG. 6, from the pet toy for replacement of the pet toy 112.

Although the pin is preferably secured to the support 122 by friction, other means, such as a threaded connection between the pin and the support, may alternatively be used.

With the pet toy 112 secured to the holder 110 by the pin 140, the pet may chew on the pet toy 112. However, as before, the pet will not be able to remove the pet toy 112 from the holder 110.

If it is desired to allow the pet to move the pet toy 112 together with the holder 110, the base 114 is relatively small so that the pet may bite the pet toy 112 without stepping on the base 114. However, if it is desired that the pet not be able to move the holder 110, the base 114 is dimensioned sufficiently large so that, when the pet bites the pet toy 112, at least one foot of the pet is positioned on top of the base 114 thus holding the base 114 in position by the weight of the pet.

From the foregoing, it can be seen that the present invention provides a simple yet effective holder for a pet toy. Having described my invention, however, many modifications thereto will become apparent to those skilled in the art to which it pertains without deviation from the spirit of the invention as defined by the scope of the appended claims.

I claim:

1. A holder for a pet toy comprising:
a base having a top,
a support secured to and extending upwardly from said top of said base, said support having an upper support surface and a notch formed in said upper surface,
with a pet toy positioned in said notch, a pin extending through registering holes in said support and the pet toy to thereby secure the pet toy to said support.

2. The holder for a pet toy as defined in claim 1 wherein said pin is retained to said support by a frictional fit between said pin and said support.

3. The holder for a pet toy as defined in claim 1 wherein a portion of said pin is knurled.

4. The holder for a pet toy as defined in claim 1 said registering holes comprise registering holes formed in opposite sides of said support notch.
